(19) United States
(12) Patent Application Publication
(10) Pub. No.: US 2015/0056460 A1
(43) Pub. Date: Feb. 26, 2015

(54) PROTECTIVE NATURAL GEL SYSTEM

(71) Applicant: PROFESSOR SIGGE & MARTIN AB, Björkö (SE)

(72) Inventor: Sigfrid Svensson, Gards Kopinge (SE)

(21) Appl. No.: 14/384,274

(22) PCT Filed: Mar. 11, 2013
(86) PCT No.: PCT/SE2013/050218

§ 371 Date: Sep. 10, 2014

(30) Foreign Application Priority Data
Mar. 13, 2012 (SE) 1250234-0

(51) Int. Cl. A01N 25/10; A23B 7/16; B08B 7/00; C04B 41/48

(52) U.S. Cl. CPC A01N 25/10; C04B 41/4807; A23B 7/16; B08B 7/0014
USPC 428/478.2; 106/2; 427/154; 427/4; 134/4

(57) ABSTRACT

The present invention relates to a protein/peptide composition for protection of surfaces comprising an aqueous solution of at least two components, the first component (A) being a water-soluble protein or a mixture of water-soluble proteins having an average molecular weight Mw of at least 30000, and being capable of forming a gel, and the second component (B) being a water-soluble peptide or a mixture of water-soluble peptides mixture having an average molecular weight of 200-10000, and being capable of inhibiting gel formation in said composition. The present invention further relates to a method for preparing such a composition, the use of the composition for protecting a surface, a method for protecting a substrate surface using the composition, and to a substrate surface coated with the composition.

### FIELD OF INVENTION

The present invention relates to compositions and methods for protecting surfaces from non-desired contaminations and for facilitating removal of such contaminations from the surfaces.

### BACKGROUND

Temporary coatings are useful in many different applications such as protection from all types of surfaces from graffiti, traffic pollution, bird droppings etc. Proteinaceous coatings are preferred because they have a natural origin.

In WO 01/04223 there is described a proteinaceous coating for protecting surfaces against deposits and contamination. The coating comprises a proteinaceous substance such as gluten. The substance is suspended in a liquid and heated under stirring. Additives, such as a cross-linking agent or matrix forming agent, may be added to the suspension. The proteinaceous substance (such as gluten) is relatively water-insoluble and the cross-linking agent can provide the coating a better resistance to water.

A problem with a coating as described in WO 01/04223 is that during preparation of a suspension with the proteinaceous substance in liquid, heating is necessary. When using e.g. collagen and gelatin such substances would form a gel during cooling, before it is possible to apply it to a surface. In addition, a cross-linking agent or matrix forming agent is needed in order to bind together the components in the suspension.

Another disadvantage with a protein suspension as described in WO 01/04223 is that a suspension is not homogenous and would not provide a homogenous film when the substance is applied onto a surface. Paint, e.g. graffiti, would be able to penetrate through a coating protecting an underlying surface, and hence the paint may reach the surface.

There is a demand for a new composition which produces coatings with a sufficient thickness and stability against rain as well as achieving removal at lower temperatures, but without the drawbacks encountered by water-resistance and gel formation prior application to a surface.

### SUMMARY OF THE INVENTION

It is an object of the present invention to alleviate at least some of the drawbacks associated with the prior art techniques.

In particular it is an object of the invention to provide a proteinaceous composition which allows application by conventional methods of a protein film having sufficient thickness as well as rain stability.

It is another object of the invention to provide a protein film or coating which may easily be removed at low temperature from a surface onto which it has been applied.

It is another object of the invention to provide a proteinaceous composition for a carrier coating for insecticides and fungicides that can be used on different types of plants for preventing rain or UV to reduce their life-time.

A further object of the invention is to provide a composition based on protein technology together with low- and high-molecular weight buffer systems to give easily removable coatings to control pH to protect against acid and alkaline contaminations.

Yet another object of the invention is to provide a mulching film.

In order for a protective film to be effective, the thickness of the protein film has to be sufficient. Sufficient film thickness can generally be achieved in two ways. The first way is by repeated application of the solution to the surface resulting in successive build-up of a sufficient thickness. Such a method carries the obvious disadvantage of having to apply the solution several times and allowing the film to dry between the applications, making the coating procedure time consuming and expensive. The second way is by single application of a solution having a sufficient dry weight to provide a sufficiently thick film. The problem with this is that an increase of dry weight may result in an increase in the viscosity of the solution, such that coating of the solutions using conventional coating techniques will be difficult.

The above mentioned objects, as well as other objects that will be apparent to a person skilled in the art when presented with the present disclosure, are accomplished by the different aspects of the present invention.

In a first aspect thereof, the present invention provides a protein/peptide composition for protection of surfaces comprising an aqueous solution of at least two components,

the first component (A) being a water-soluble protein or a mixture of water-soluble proteins having an average molecular weight Mw of at least 30000, and being capable of forming a gel, and

the second component (B) being a water-soluble peptide or a mixture of water-soluble peptides having an average molecular weight Mw of 200-10000, and being capable of inhibiting gel formation in said composition,

wherein the weight ratio between A and B is in the range of from 20:1 to 1:20 based on dry weight of A and B, and the total concentration of A and B in the composition is in the range of 0.1-30% (w/v) based on dry weight of A and B.

The present invention makes use of the advantage of gel formation as an intermediary step. More specifically, the invention is based on the inventive realization that the gel formation of proteins or mixtures of different proteins can be inhibited by the addition of peptides or a mixture of different peptides. Typically, the protein(s) of the first component (A) have a molecular weight Mw of above 30000 Da and the peptide(s) of the second component (B) have a molecular weight Mw in the range of 200-10000 Da. The protein(s) of the first component (A) can be referred to as a high molecular weight protein. The peptide(s) of the second component (B) encompass also longer peptides, up to approximately 100 amino acid residues. Thus, the peptides according to the invention include peptides which may also be referred to as low molecular weight proteins, especially when they have a molecular weight Mw of above approximately 5000 Da and have an ordered structure.

If a protein, which has the ability to form a gel, is used alone in solution, the concentration thereof has to be very low to obtain a solution that can be applied without difficulty due to premature gel formation. If the concentration of the protein is increased to a level, which would result in sufficient film thickness when the solution is applied to a substrate, then gel formation will occur and the application by spraying or alike will constitute a severe problem. In other words, a problem to be solved by the invention can be said to reside in finding new techniques, whereby it is possible to make use of the advantages associated with gel formation as an intermediate stage in the formation of protein coatings, while at the same time providing for a concentration of proteins in the coating solution resulting in a protective film of sufficient thickness. The present invention solves this problem and thereby constitutes a significant advance in the art.

When a solvent is evaporated from a solution comprising a protein capable of forming a gel, the concentration of the protein will eventually reach a critical point at which gel formation occurs. This critical point is important in the manufacture of and use of protein coatings. The gel formation should preferably occur during the evaporation of the remaining solvent in the coating before a solid film is formed on the substrate. If gel formation occurs too soon, i.e. before sufficient wetting of the substrate, the properties of the protective film, in terms of coverage and adhesion, will be adversely affected. If gel formation does not occur before the film is formed, the water resistance and mechanical properties of the protective film will be adversely affected. The present invention provides for the timing of the gel formation in the film to be tailored by varying the weight ratio between the different components to optimize the properties of the finished protective film.

The compositions and methods of the present invention have several surprising advantages over the compositions and methods of the prior art.

Significant advantages of the present invention as compared with the compositions and methods of the prior art, is that it provides for obtaining a thick film with few or even a single application without compromising the stability of the film towards water at room temperature.

The invention also provides for avoiding the problem of hysteresis i.e. difference in gel setting and gel melting temperature. This phenomenon is very common among polysaccharides capable of forming gels. Thus, for example agar gels has a setting temperature of about 40° C. and a melting temperature of 85° C. This makes it difficult to form a water-stable film at room temperature which can be removed at low temperatures.

Another advantage is that a film formed by the composition according to the present invention can easily be removed from a surface to protect. The film can be removed (washed off) by using a liquid, e.g. water, at a temperature of below 40° C. in order to provide a clean surface. A protein film comprising a protein/peptide composition according to the present invention can absorb some liquid, e.g. water, to a certain extent to form a gel. This phenomenon facilitates removal of the film from a surface to protect, because the film in the form of a gel is easier to at least partially remove from the underlying surface compared to a hydrophobic coating.

The composition of the present invention allows a high total concentration of proteins without the disadvantage of very high viscosity of the solution as often is the case with other polymer solutions. The peptide component B prevents premature gel formation of the protein component A and therefore permits a high concentration of gel forming proteins without the disadvantage of gel formation.

The present inventor has surprisingly found that peptides obtained from gel forming proteins can inhibit the gel formation which has made it possible to formulate a non-gel composition which allows for application onto substrates by conventional methods. On evaporation the applied solution will form a gel before making a solid film.

The composition of the present invention comprises an aqueous solution of at least one protein capable of forming a gel, and at least one peptide being capable of inhibiting gel formation of said protein. The protein(s) and peptide(s) may be partially or completely dissolved in the aqueous solution. Preferably the protein(s) and peptide(s) are completely or substantially completely dissolved in the aqueous solution. In an embodiment, the composition consists of said solution.

The composition of the invention comprises as component A, at least one protein capable of forming a gel, either by itself or by interaction with other components in the composition.

The average molecular weight Mw of component A, i.e. the protein, which is capable of forming a gel is preferably 30000 or higher, such as 50000 or higher or such as 70000 or higher. In an embodiment, wherein the average molecular weight Mw is 30000 or higher, or 50000 or higher or 70000 or higher, preferably at least 75% of the proteins should have a molecular weight above that value. In an embodiment, wherein the average molecular weight Mw is in the range of 30 000-200000, or in the range of 50000-100000, preferably at least 75% of the proteins should have a molecular weight within the respective range.

Gel formation may occur by a number of different mechanisms, but the exact mechanism of the gel formation is not of essence to the present invention. Gel formation also depends on the temperature and concentration of the protein solution.

The skilled person will recognize which proteins or mixtures of proteins that may be subject to gel formation.

The composition of the invention may for example comprise, as component A, a protein capable of forming a gel by itself.

In an embodiment, the protein capable of forming a gel, i.e. component A, is selected from the group consisting of collagens, gelatins, caseins, keratins and soy bean proteins, and mixtures thereof. In another embodiment, component A is selected from the group consisting of collagens, gelatins, caseins and keratins.

In an embodiment, the protein capable of forming a gel, i.e. component A, is selected from the group consisting of collagens, gelatins, caseins and soy bean proteins, and mixtures thereof. In another embodiment, component A is selected from the group consisting of collagens, gelatins and caseins. Preferred examples of component A is collagen and gelatin.

The composition of the invention comprises as component B at least one peptide or a mixture of peptides capable of inhibiting the formation of a gel of the composition comprising component A, either by interaction with component A or by interaction with other components in the composition. As evident below, component B prevents gel formation of the composition comprising component A prior to application onto a substrate surface. When the composition is applied onto a substrate surface and is allowed to dry, a film will be formed from the composition via at least partial gel formation.

The average molecular weight Mw of component B, i.e. the peptide or mixture of peptides, is generally in the range of 200-10000, and preferably within a range of 400-5000, and preferably at least 75% of the peptides should have a molecular weight within said range. A lower molecular weight Mw than 200 may lead to a high portion of low molecular species which are not bound strongly enough within the formed film and may easily be washed out, or diffuse out, of the film. A molecular weight Mw higher than 10000 may not give the advantage of low viscosity in solution. Although all amino acid stretchers of less than approximately 100 residues are termed peptides according to the present invention, a peptide having a molecular weight Mw above about 5000 Da can sometimes be referred to as a low molecular weight protein.

Examples of peptides or mixtures of peptides suitable for use as the low molecular weight component B in the inventive composition include, but are not limited to, low molecular weight species of all the different proteins mentioned above in relation to proteins (component A). The peptide or mixture of peptides can for example be derived from the group consisting of collagens, gelatins, caseins, keratins and soy beans, and mixtures thereof. For example, the peptide or mixture of peptides can be derived from the group consisting of collagens, gelatins, caseins and soy beans, and mixtures thereof.

Peptides suitable for use with the present invention may be obtained by a number of different methods. In a preferred embodiment, the peptide or mixture of peptides comprises a hydrolysate of a protein. A protein hydrolysate is a product from hydrolytic degradation of a protein resulting in cleavage of peptide bonds. Hydrolysis may be effected by methods such as acid hydrolysis or enzymatic hydrolysis. Hydrolysis allows for the preparation of a mixture of peptides with the desired average molecular weight. Hydrolysis may also be combined with a method of separating peptides from the mixture formed by hydrolysis, such as dialysis or gel filtration. Hydrolysis and separation of peptides allow the molecular weight distribution and the average molecular weight Mw to be tailored within a wide range.

In an embodiment, the peptide(s) of component B is derived from a different protein(s) than the protein(s) of component A. In another embodiment, the peptide(s) of component B is derived from the same type of protein(s) as the protein(s) of component (A).

In one embodiment, component A is collagen and component B is collagen hydrolysate. In one embodiment, component A is gelatin and component B is gelatin hydrolysate. In one embodiment, component A is casein and component B is casein hydrolysate. In one embodiment, component A is keratin and component B is keratin hydrolysate. In one embodiment, component A is soy bean protein and component B is soy bean protein hydrolysate.

Inhibition of gel formation may occur by a number of different mechanisms, such as for example steric hindrance or competitive inhibition, but the exact mechanism of the inhibition of gel formation is not of essence to the present invention. Generally the degree of inhibition increases with increasing concentration of the peptide(s) relative to the concentration of the protein(s). If the relative concentration of the peptide(s) is too low, gel formation may occur too early in the evaporation process and the adhesion to the surface of the substrate may be negatively affected. If the relative concentration of the peptide(s) is too high, the stability of the resulting protective film towards water may be negatively affected. The weight ratio between the peptide(s) and the protein(s) should therefore be selected within a range which does not give premature gel formation, and which provides a protective film which is stable towards water at room temperature.

The weight ratio between the protein(s) and the peptide(s) required for each specific composition can easily be determined by routine experimentation. Depending on the desired properties of the formed film, the ratio between the protein(s) and the peptide(s) may be varied within a very wide range.

The weight ratio between A and B may preferably be below 20:1 based on dry weights, such as below 10:1, 5:1, 2:1 or 1:1, and preferably above 1:20, such as above 1:10, 1:5, or 1:2.

In an embodiment, the weight ratio between A and B is in the range of from 20:1 to 1:20 based on dry weight of A and B. In another embodiment, the weight ratio between A and B is in the range from 10:1 to 1:10 based on dry weight of A and B. In an embodiment, the weight ratio between A and B is in the range of from 5:1 to 1:5 based on dry weight of A and B. In yet another embodiment, the weight ratio between A and B is in the range of from 2:1 to 1:2 based on dry weight of A and B.

For use in removable protective coatings it has been found that a weight ratio between A and B in the composition may advantageously be in the range of 5:1 to 1:5 based on dry weight of A and B. Preferably the weight ratio between A and B in the composition may advantageously be in the range of 2:1 to 1:2. Such compositions have been found to allow suitable total protein/peptide concentrations at acceptable viscosity, while providing protective films having a balance between excellent protective properties and removability.

The total concentration of protein(s) and peptide(s) in the inventive composition will affect the thickness of a film formed by the composition. The higher the concentration of protein(s) and peptide(s), the thicker the protective film. The total concentration of protein(s) and peptide(s) should preferably be selected so that the mixture of the components A and B will not form a gel at room temperature and thus allowing the application of the solution onto the surface of a substrate using conventional methods such as spraying, brushing or pouring.

The total concentration of protein(s) and peptide(s), i.e. component A and component B, in the inventive composition is preferably at least 0.1% (w/v) based on dry weight of A and B, such as at least 0.5%, at least 1%, at least 2%, at least 5%, at least 10% or at least 20% and the total concentration of protein(s) and peptide(s), i.e. component A and component B, in the inventive composition is preferably not higher than 30% (w/v) based on dry weight of the protein(s) and peptide(s), such as not higher than 20%, 10% or 5%.

The total concentration of protein(s) and peptide(s), i.e. component A and component B, in the inventive composition may preferably be in the range of 0.1-30% (w/v) based on dry weight of A and B, more preferably in the range of 1-20% (w/v) or 1-10% (w/v) based on the dry weight of A and B. The use of peptides according to the present invention allows for the use of higher amino acid concentrations in the solutions as compared to the compositions comprising only high molecular weight proteins. Prior art compositions comprising protein forming gels cannot be kept as solutions at room temperature at the above mentioned concentration levels.

The concentration in the composition of component A, i.e. the protein or mixture of proteins capable of forming a gel, should be sufficiently high to allow for the formation of a gel when the water in the composition evaporates. The concentration in the composition of component A, i.e. the protein or mixture of proteins capable of forming a gel, should also preferably be sufficiently low to allow for the inhibition of the gel formation by the addition of component B, i.e. the peptide or mixture of peptides according to the invention. The concentration of the protein or mixture of proteins capable of forming a gel may generally be at least 0.1% (w/v) based on dry weight of A, such as at least 0.5%, at least 1%, at least 5% or at least 10%. The concentration of protein or mixture of proteins capable of forming a gel may generally be below 10% (w/v) based on dry weight of A, such as below 5% or below 2% in order to allow for the inhibition of gel formation by peptides or mixture of peptides.

In an embodiment, the concentration of the protein or mixture of proteins capable of forming a gel may be in the range of 0.1-10% (w/v) based on dry weight of A. In another embodiment, the concentration of protein or mixture of proteins is in the range of 0.5-5% (w/v) based on dry weight of A. In a further embodiment, the concentration of the protein or mixture of proteins is in the range of 0.1-2% (w/v) based on dry weight of A.

The concentration in the composition of component B, i.e. the peptide or mixture of peptides capable of inhibiting the formation of a gel in the composition, either by interaction with component A or by interaction with other components in the composition should preferably be sufficiently high to obtain a desired inhibition of gel formation in the composition as well as to obtain a sufficiently thick film when the composition is applied to a substrate and allowed to dry, and sufficiently low to not completely inhibit gel formation so that no gel is formed by evaporation of the solvent before film formation. The concentration of component B, i.e. the peptide or mixture of peptides capable of inhibiting the formation of a gel in the composition may generally be at least 0.1% (w/v) based on dry weight of B, such as at least 0.5%, at least 1%, at least 5%, at least 10% or at least 20%.

In an embodiment, the concentration of the peptide or mixture of peptides is in the range of 0.1%-30% (w/v) based on dry weight of B. In another embodiment, the concentration of the peptide or mixture of peptides is in the range of 1-20% (w/v) based on dry weight of B. In another embodiment, the concentration of the peptide or mixture of peptides is in the range of 5-20% (w/v) based on dry weight of B.

The composition of the invention may further comprise additives for improving the properties of the films formed thereof.

In an embodiment, the composition further comprises an anti-foaming agent. The addition of an anti-foaming agent is particularly advantageous in compositions with high viscosity, since such compositions when applied onto substrates may contain air bubbles. Bubbles remaining in the film may lead to the formation of pinholes in the solid film. Pinholes increase the permeability of the film towards contamination of the substrate. The addition of anti-foaming agent changes the surface tension and thus reduces the pinhole formation. Examples include n-octanol or similar higher aliphatic alcohols, although any suitable anti-foaming agent may be used.

In an embodiment, the composition further comprises a plasticizer. Plasticizers help to make the resulting film flexible. This is important in order to eliminate cracks in the film during the drying process. Cracks increase the permeability of the film towards contamination. Examples include glycerols or poly-glycerols, although any suitable plasticizer may be used.

In an embodiment, the film further comprises a surfactant. Surfactants reduce the surface tension of the composition and facilitate the spreading of the composition on a substrate, and the filling of pores present in the substrate. A person skilled in the art may select a surfactant suitable for the use with the present invention.

In an embodiment, the composition is preferably provided with a pH buffer system for the purpose of counteracting changes in the pH of the film formed dependent on exterior influence. This is suitable particularly to withstand influence of environmental conditions, such as acid rain, bird droppings and other conditions involving acid or basic pH.

In an embodiment, the composition further comprises a component for increasing the viscosity of the composition. In an embodiment, the composition is preferably provided with a polysaccharide or mixture of polysaccharides to increase the viscosity of the composition. Many protein solutions, even at high concentrations, exhibit low viscosity which can make it difficult to apply the composition onto vertical surfaces without having flow of the composition. Polysaccharides or mixtures of polysaccharides increase the viscosity at even low concentrations.

In an embodiment, the composition comprises an antimicrobial agent and/or a preservative. An antimicrobial agent may reduce decay of the protein/peptide composition or film due to microbial activity. Examples include benzoates, such as methyl paraben.

In an embodiment, the composition further comprises a primer, such as chitosans or polyethylene imines.

In an embodiment, the composition further comprises at least one additive selected from the group consisting of an anti-moss agent, an insecticide, a fungicide, and an herbicide. Examples of an anti-moss agent include Mogeton. Examples of an insecticide include Cypermethrin and Imidazopyridine. Examples of a fungicide include Resplend and Decabane. Examples of an herbicide include Roundup.

The composition of the present invention may also be present in the form of a concentrate which may be diluted before use with a suitable solvent, e.g. water, to a desired final concentration. A concentrate of the composition of the present invention has the advantage of reducing costs for packaging and transportation of the product. In an embodiment, the concentrate comprises a total concentration of protein(s) and peptide(s) in the range of 10-30% (w/v), preferably 15-25% (w/v) based on dry weight of the components.

The invented composition may advantageously be used for protection of surfaces against non-desired contamination, such as from so called graffiti, traffic pollution, bird droppings etc. Therefore, in a second aspect thereof, the present invention provides the use of a protein/peptide composition as defined according to the first aspect of the invention for protecting a substrate from contamination and facilitating removal of contamination therefrom.

Using the inventive composition according to the second aspect of the invention allows for the formation on substrates of protective films having sufficient thickness and stability towards water at room temperature with a single coating application, significantly reducing the costs for protecting surfaces.

In a third aspect thereof, the present invention provides a process for the preparation of a protein/peptide composition suitable for application on surfaces comprising the steps:

a) mixing a first component (A) being a water-soluble protein or a mixture of water-soluble proteins having an average molecular weight Mw of at least 30000, and being capable of forming a gel, and a second component (B) being a water-soluble peptide or a mixture of water-soluble peptides having an average molecular weight Mw of about 200-10000, and being capable of inhibiting gel formation of A, water, and optionally other components, wherein the weight ratio between A and B is in the range of from 20:1 to 1:20 based on dry weight of A and B, and the total concentration of A and B in the composition is in the range of 0.1-30% (w/v) based on dry weight of A and B,

b) heating the mixture of a) to a temperature of at least 60° C. to dissolve the components A and B and optionally other components in the water, and

c) allowing the solution obtained in b) to cool down to room temperature.

The composition in the third aspect may comprise any feature mentioned herein in relation to the composition of the first aspect of the invention.

The composition of the invention comprises an aqueous solution of protein(s) and peptide(s), wherein the protein(s) may be present in a concentration at which it would normally form a gel at room temperature, but wherein gel formation is inhibited by the peptide(s). Preparation of such solutions may be difficult since addition of the protein at room temperature may result in full or partial gel formation in the solution. This problem may be overcome by heating the composition to a temperature at which the protein(s) and the peptide(s) are fully dissolved, and thereafter allowing the solution to cool down to room temperature. The present inventor has surprisingly found that this process allows for the preparation of solutions with high concentration of gel forming proteins without the occurrence of gel formation when the solution is cooled down.

It is believed that the reason for this is that gel formation is inhibited by the peptide(s) of the composition, although the disclosure of the present invention is not bound by any specific theory. The present process may be particularly advantageous in the preparation of a concentrate of the composition of the invention since the protein concentration in such solutions is especially high.

In some cases it may be useful to heat the mixture in step b) to a higher temperature to facilitate dissolution of the protein(s) and peptide(s). In an embodiment, the temperature of step b) is at least 70° C., such as for example at least 80° C.

In a fourth aspect thereof, the invention provides a process for protecting a substrate from contamination and facilitating removal of contamination therefrom, comprising the following steps:

a) providing a protein/peptide composition according to the present invention,

b) applying the aqueous protein/peptide composition of a) to a substrate surface which is to be subjected to contamination, and

c) allowing the applied composition to dry to form a protective film on said substrate surface.

The process as outlined above resides in principal in proceeding from a protein/peptide composition, to an intermediate gel and to a solid film.

This process makes use of the inherent advantageous feature of the inventive composition in the formation of a protective film on a surface. The method according to the fourth aspect of the invention allows the formation of protective films on substrates having sufficient thickness and stability towards water at room temperature with few applications or even a single coating application, significantly reducing the costs for protecting surfaces.

In step a) of the process, a composition as described in the first aspect of the invention is provided. In step b) the composition is applied to a surface which is to be protected from contamination. Upon evaporation of the solvent in step c) from the composition applied to the surface, there will be formed a gel which is finally converted into a solid film. The resulting film resists dissolution by water at room temperature, since treatment with water only results in swelling of the film to a gel, unless the temperature is increased so that the gel can reach its melting temperature and the film can be dissolved.

In a specific embodiment, the application of the solution in step b) is performed in a single step. Single step application greatly reduces cost and effort associated with the protection of surfaces.

The composition in the fourth aspect may comprise any feature mentioned herein in the relation to the composition of the first aspect of the invention.

The thickness of the protective film formed according to the process of the present invention is important for the protective performance of the film. Generally, a film thickness of 1 μm may be sufficient for covering a smooth flat surface. However, most surfaces contain small or large irregularities, defects or pores, that may affect the film in such a way that the surface coverage of a thin film will not be satisfactory. Furthermore, on surfaces exposed to for example to an outdoor environment, the protective film may be eroded by rain, wind and particles, and by contact with passers-by, such that the film thickness is decreased over time. It is therefore generally desired to have a thicker protective film. A thicker film also provides better protection, e.g. against graffiti, since it increases the time required for a paint to diffuse through the protective film and reach the underlying substrate. The present invention allows the application of films having a thickness of at least 20 μm in a single application.

Therefore, in an embodiment of the process of the invention, the protective film resulting from step c) has a thickness of at least 10 μm, preferably at least 20 μm on said substrate surface.

The protective film formed when the inventive formulation is applied to a surface may preferably be removable by treatment with water at elevated temperatures.

In an embodiment the process further comprises the steps of:

d) treating the film formed in step c) with a liquid capable of redissolving and/or swelling the film, and

e) removing the contamination deposited on the film by complete or partial removal of the film from the substrate surface.

By complete or partial removal of the protein/peptide film from the surface which it covers, any contamination deposited on the film after it was applied may be removed.

The liquid capable of redissolving and/or swelling the film is preferably water based, such as water. The liquid may have an elevated temperature as compared to room temperature. In an embodiment the temperature of the liquid is above 30° C. and preferably above 40° C. The temperature may preferably be in the range of 30-80° C., such as in the range of 40-60° C. In a preferred embodiment, the liquid capable of re-dissolving and/or swelling the film is water at a temperature of about 40-60° C.

In order to further facilitate removal of the film, the liquid may be applied at elevated pressure, for example using a high pressure cleaning apparatus. The pressure of the liquid may generally be in the range of 20-100 bars depending on the surface on which the protective film is deposited. In an embodiment, the pressure of the liquid is above 25 bars, such as above 40 bars, or such as above 80 bars. In another embodiment, the pressure of the liquid is preferably in the range of 50-80 bars.

In an embodiment, the liquid capable of redissolving and/or swelling the film comprises an enzyme, or a functional portion of an enzyme, capable of degrading a protein or peptide present in the film. In other words, the liquid capable of redissolving and/or swelling the film may comprise a proteolytic enzyme. Enzymatic degradation of the film can significantly facilitate removal film since the degradation increases the solubility of the film. Using enzymatic degradation thus allows for removal of the film at lower temperature and liquid pressure than required for removal of a corresponding undegraded film. This may for example be very useful when the film is used for protection of sensitive substrates.

The enzyme, or a functional portion of an enzyme, may be any enzyme or mixture of enzymes capable of degrading a protein or peptide present in the film. Such proteolytic enzymes are readily recognized by a person skilled in the art. The enzyme may be effective for the degradation of a variety of proteins or it may be specific to the degradation of a protein or peptide present in the film. It has been found that some enzymes present in common fruits may be advantageously employed in the present invention. For example, bromelain (pineapple fruit), papain (papaya fruit), actinidin (kiwi fruit) or ficin (figs) may be used.

Thus in an embodiment, the enzyme is selected from the group consisting of bromelain, papain, actinidin and ficin, or a mixture thereof. In an embodiment the enzyme is bromelain.

A suitable concentration of the enzyme or a functional portion of enzyme in the liquid may be readily determined by a person skilled in the art. The concentration of enzyme in the liquid may generally be in the range of 0.01 to 10% (w/v), such as in the range of 0.1 to 5% (w/v), such as in the range of 0.5 to 2% (w/v).

In a fifth aspect thereof, the present invention provides a substrate having a surface coated with a protective film comprising a first component (A) being a water-soluble protein or a mixture of water-soluble proteins having an average molecular weight Mw of at least 30000, and being capable of forming a gel, and a second component (B) being a water-soluble peptide or mixture of water-soluble peptides having an average molecular weight Mw of about 200-10000, and being capable of inhibiting gel formation of A, wherein the weight ratio between A and B is in the range of from 1:20 to 20:1 based on dry weight of A and B.

When a composition according to the present invention has been applied to a surface, water will evaporate from the film resulting in an increase in the concentration of the components in the film. When the protein/peptide concentration has reached a certain level, gel formation will occur, resulting in a significant increase of the stability of the film. Evaporation of water may then proceed until equilibrium water content in the film has been reached. The protective film thus formed may have properties superior to the properties of the prior art, since coverage and adhesion of the film on the substrate can be optimized by tailoring the point at which gel formation occurs.

In an embodiment, the thickness of the protective film may be in the range of 5-100 μm, such as in the range of 10-50 μm.

The substrate may preferably be coated with a protective film obtained by the above mentioned process. The protective film is advantageously homogenous.

In an embodiment, the substrate is selected from a group consisting of concrete, metal, stone, glass or wood. The substrate may also be a paint or varnish coated surface, such as e.g. a vehicle body.

If the substrate onto which the inventive composition is applied is porous, the composition may enter the pores of said substrate to form an impregnated substrate. The composition of the invention is especially advantageous in this respect, since it allows a high concentration of proteins/peptides in the solution, while maintaining a relatively low viscosity of the solution. Low viscosity is advantageous for allowing efficient impregnation of porous substrates.

The inventive composition may also be used for the impregnation of porous cloth, tissue or weave, for example cellulose or wool based, such as paper, to obtain a product with improved water resistance. The porous material may preferably be susceptible to biodegradation. Such protein/peptide impregnated cloth, tissue or weave is useful for a biodegradable material, e.g. for covering the soil between desired plants in a plantation in order to reduce weed growth. The life time of the impregnated material may be extended by suspending the material above the ground such that the contact of the impregnated material and the soil is reduced or eliminated. When the material is no longer required, degradation may be accelerated by increasing the contact of the impregnated material with the soil. The inventive material thus provides an efficient and environmentally friendly alternative to herbicides. Another advantage of the impregnated material is that is allows water, e.g. from rain or artificial irrigation, to pass through the material. Many prior art materials are plastic based and do not allow passage of water.

In an embodiment, the present innovation provides a porous material impregnated with a protein/peptides composition as defined herein. The porous material may preferably be cellulose based. In an embodiment, the porous material is paper. In a more specific embodiment the impregnated paper is a tissue paper impregnated with a composition according to the present invention wherein the protein component A is collagen and the peptide component B comprises a collagen hydrolysate. The composition used for impregnating the porous material may also further comprise a pigment, such as carbon black, to reduce the transparency to sunlight of the material.

In a sixth aspect thereof, the present invention provides the use of a composition according to the invention, further comprising a plasticizer and an insecticide and/or fungicide, for protecting a plant or a plant part.

The composition is applied to a plant or plant part, e.g. by spraying or dipping. The composition then dries to form a protective film on the surface of said plant or plant part, wherein the formed film comprises an insecticide and/or a fungicide.

Preferably, the composition in this aspect of the invention comprises a high amount of plasticizer, such as more than 25% (w/w) or more than 50% (w/w) based on the total weight of component A and component B. In an embodiment, the composition in this aspect of the invention comprises at least 75% (w/w) of a plasticizer based on the total weight of component A and component B. The plasticizer may for example be glycerol or a polyglycerol. Preferably the plasticizer is glycerol.

The high amount of plasticizer in the protective film allows the film to expand more than 20% without cracking. The expanded film will on watering (artificially or by natural rain) absorb the water whereby the expansion pressure is alleviated. On drying the film will dry back to the new surface area of the growing plant part.

In order to provide for better adherence to plant parts (which sometimes have water repelling properties) polyimines or other polyamino compounds may be added to the composition.

The term “protein”, as referred to herein, means a molecule comprising amino acids connected by amide (peptide) bonds having an average molecular weight Mw of at least 30000. A protein with a molecular weight Mw above approximately 30000 may also be referred to as a high molecular weight protein.

The term “peptide”, as referred to herein, means a molecule comprising amino acids connected by amide (peptide) bonds having an average molecular weight in the range of 200 to 10000. A peptide with a molecular weight Mw above approximately 5000 may also be referred to as a low molecular weight protein.

The molecular weight Mw used herein refers to the weight average molecular weight of the proteins or peptides, which is well defined in the scientific literature.

### ITEMIZED LISTING OF EMBODIMENTS

The following is a non-limiting and itemized listing of embodiments of the present disclosure, presented for the purpose of describing various features and combinations provided by the invention in certain of its aspects.

Items:

1. A protein/peptide composition for protection of surfaces comprising an aqueous solution of at least two components,
the first component (A) being a water-soluble protein or a mixture of water-soluble proteins having an average molecular weight Mw of at least 30000, and being capable of forming a gel, and
the second component (B) being a water-soluble peptide or a mixture of water-soluble peptides having an average molecular weight Mw of 200-10000, and being capable of inhibiting gel formation in said composition,

wherein the weight ratio between A and B is in the range of from 20:1 to 1:20 based on dry weight of A and B, and the total concentration of A and B in the composition is in the range of 0.1-30% (w/v) based on dry weight of A and B.

2. A protein/peptide composition according to item 1, wherein the weight ratio between A and B is in the range from 5:1 to 1:5 based on dry weight of A and B.

3. A protein/peptide composition according to item 2, wherein the weight ratio between A and B is in the range from 2:1 to 1:2 based on dry weight of A and B.

4. A protein/peptide composition according to any of the preceding items, wherein the total concentration of A and B in the solution is in the range of 1-20% (w/v) based on dry weight of A and B.

5. A protein/peptide composition according to item 4, wherein the total concentration of A and B in the solution is in the range of 1-10% (w/v) based on dry weight of A and B.

6. A protein/peptide composition according to any of the preceding items, wherein A is selected from the group consisting of collagens, gelatins, caseins, keratins and soy bean proteins, and mixtures thereof.

7. A protein/peptide composition according to item 6, wherein A is selected from the group consisting of collagens, gelatins, caseins, and keratins.

8. A protein/peptide composition according to item 6, wherein A is selected from the group consisting of collagens, gelatins, caseins and soy bean proteins, and mixtures thereof.

9. A protein/peptide composition according to item 8, wherein A is selected from the group consisting of collagens, gelatins and caseins.

10. A protein/peptide composition according to item 9, wherein A is selected from the group consisting of collagens and gelatins.

11. A protein/peptide composition according to any one of the preceding items, wherein B is derived from the same protein as A.

12. A protein/peptide composition according to any one of the preceding items, wherein B comprises a hydrolysate of a protein.

13. A protein/peptide composition according to any one of items 1-5, wherein component A is collagen and component B is collagen hydrolysate.

14. A protein/peptide composition according to any one of items 1-5, wherein component A is gelatin and component B is gelatin hydrolysate.

15. A protein/peptide composition according to any one of items 1-5, wherein component A is casein and component B is casein hydrolysate.

16. A protein/peptide composition according to any one of items 1-5, wherein component A is keratin and component B is keratin hydrolysate.

17. A protein/peptide composition according to any one of items 1-5, wherein component A is soy bean protein and component B is soy bean protein hydrolysate.

18. A protein/peptide composition according to any one of the preceding items, further comprising at least one additive selected from the group consisting of an anti-foaming agent, a plasticizer, a surfactant, a primer, an antimicrobial agent, a preservative, an anti-moss agent, an insecticide, a fungicide, an herbicide, and a component for increasing the viscosity of the composition.

19. A protein/peptide composition according to item 18, wherein said component for increasing the viscosity is selected from the group consisting of polysaccharides or mixtures thereof.

20. Use of a protein/peptide composition as defined in any one of the preceding items for protecting a substrate from contamination and facilitating removal of contamination therefrom.

21. A process for the preparation of a protein/peptide composition suitable for application on surfaces comprising the steps:
a) mixing a first component (A) being a water-soluble protein or a mixture of water-soluble proteins having an average molecular weight Mw of at least 30000, and being capable of forming a gel, and a second component (B) being a water-soluble peptide or a mixture of water-soluble peptides having an average molecular weight of about 200-10000, and being capable of inhibiting gel formation of A, water, and optionally other components, wherein the weight ratio between A and B is in the range of from 20:1 to 1:20 based on dry weight of A and B, and the total concentration of A and B in the composition is in the range of 0.1-30% (w/v) based on dry weight of A and B,
b) heating the mixture of a) to a temperature of at least 60° C. to dissolve the components A and B and optionally other components in the water, and
c) allowing the solution obtained in b) to cool down to room temperature.

22. A process according to item 21, wherein the protein/peptide composition is further defined as in any one of items 2-19.

23. A process for protecting a substrate from contamination and facilitating removal of contamination therefrom, comprising the following steps:
a) providing a protein/peptide composition as defined in any one of items 1-19,
b) applying the aqueous protein/peptide composition of a) to a substrate surface which is to be subjected to contamination, and
c) allowing the applied composition to dry to form a protective film on said substrate surface.

24. A process according to item 23, wherein the application of the composition in step b) is performed as a single application.

25. A process according to any one of items 23-24, wherein the protective film resulting from step c) has a thickness of at least 10 μm on said substrate surface.

26. A process according to any one of the items 23-25, further comprising the steps of:
d) treating the film formed in step c) with a liquid capable of redissolving and/or swelling the film, and
e) removing contamination deposited on the film by complete or partial removal of the film from the substrate surface.

27. A process according to item 26, wherein said liquid capable of redissolving and/or swelling the film comprises an enzyme, or a functional portion of an enzyme, capable of degrading a protein or peptide present in the film.

28. A process according to item 27, wherein said enzyme is selected from the group consisting of bromelain, papain, actinidin and ficin, or a mixture thereof.

29. A process according to item 28, wherein said enzyme is bromelain.

30. A process according to any one of items 26-29, wherein the concentration of enzyme or functional portion of enzyme in the liquid is in the range of 0.01 to 10% (w/v), such as in the range of 0.1 to 5% (w/v), such as in the range of 0.5 to 2% (w/v).

31. A substrate having a surface coated with a protective film comprising a first component (A) being a water-soluble protein or a mixture of water-soluble proteins having an average molecular weight Mw of at least 30000, and being capable of forming a gel, and a second component (B) being a water-soluble peptide or a mixture of water-soluble peptides having a molecular weight Mw of about 200-10000, and being capable of inhibiting gel formation of A, wherein the weight ratio between A and B is in the range of from 20:1 to 1:20 based on dry weight of A and B.

32. A substrate coated with a protective film according to item 20, wherein the thickness of the protective film is in the range of 5-100 μm.

33. A substrate according to any one of items 31-32, having a surface which is coated with a protective film by the process of any one of the items 23-25.

34. A substrate coated with a protective film according to any one of items 31-33, wherein the substrate is selected from a group consisting of concrete, metal, paint, stone, glass, wood or plant parts.

35. A substrate coated with a protective film according to any one of items 31-33, wherein the substrate is a porous cloth, tissue or weave impregnated with the composition.

36. A substrate coated with a protective film according to item 35, wherein the substrate is paper tissue.

37. Use of a composition according to any one of items 1-19, further comprising a plasticizer and an insecticide and/or a fungicide, for protecting a plant or a plant part.

The invention will be further illustrated by non-limiting examples, wherein percentages are given in weight by volume unless otherwise indicated.

### EXAMPLES

### Example 1

### Inhibition of Gel Formation

The purpose of this experiment is to demonstrate that gel formation of proteins in solution is inhibited by the addition of peptide(s).

Gelatin hydrolysate (average Mw of 4000) was added to samples of a solution of 3% (w/v) of gelatin in water at 50° C. to final concentrations of 0.5%, 1.0%, 2%, 3%,and 4% (w/v). The solutions were allowed to cool to room temperature (18° C.). It was found that the sample with 3% gelatin alone formed a strong gel, and that the addition of gelatin hydrolysate gradually weakened the gel and at a concentration of 3% or higher no gel was formed.

The above experiment was repeated using a solution of 6% (w/v) gelatin in water. No inhibition of gel formation was observed at additions of gelatin hydrolysate with a concentration up to 6%. At the addition of gelatin hydrolysate of a concentration of 12%, inhibition of gel formation was observed.

The above experiment in a) was repeated using a casein hydrolysate instead of gelatin hydrolysate. No inhibition of gel formation was observed at additions of casein hydrolysate with a concentration up to 6%.

### Example 2

### Protective Film Formation

A mixture of gelatin (average Mw 200000, 30 g) and gelatin hydrolysate (average Mw 4000, 30 g) was added to 1 litre of water under stirring. The resulting suspension was heated to 70° C. until a solution was formed. The solution was allowed to cool down to room temperature. Said solution was applied onto a concrete substrate (0.2 l/m²). On drying the liquid phase turned into a gel before forming a film.

The resulting film was fairly resistant to water (15° C.) but could be removed by the use of warm water (50° C.) at elevated pressure (50-80 bars). It was found that the film protected the concrete surface from pollutants such as bird droppings and graffiti (lacquer paints, felt pens etc.).

### Example 3

### Protective Film Formation

A mixture of casein (Mw 20-30.000, 40 g), casein hydrolysate (Mw 5-10.000, 60 g) and calcium hydroxide (1 g) was added to 1 litre of water under stirring. The resulting suspension was heated to 90° C. until a solution was obtained. After cooling to room temperature the solution was applied onto a concrete substrate (0.15 l/m²). On drying the liquid phase turned into a gel before forming a film.

The resulting film was very resistant to water (15° C.) but could be removed by the use of warm water (80° C.) at elevated pressure (50-80 bars). It was found that the film protected the concrete surface from pollutants such as bird droppings and graffiti (lacquer paints, felt pens etc.).

### Example 4

### Plant Protection

Glycerol was added to a solution prepared as above in example 2 to a final concentration of 2% (v/v). 1% (v/v) of cypermethrin in vegetable oil (10%, w/v) was then added under vigorous stirring. Conifer seedlings were then dipped in the resulting solution and allowed to dry. The seedlings were planted in an area heavily infested with Hylobius abietis (pine weevil) together with untreated conifer seedlings. After 12 months the plants were inspected and it was found that only 5% of the treated seedlings were dead, whereas among the non-treated seedlings 75% were dead due to ring barking.

### Example 5

### Fruit Protection

A solution containing cypermethrin prepared as under example 4 was sprayed onto small apples newly formed. During the next three months the apple trees were irrigated (naturally or artificially) once a week. The surface area of the apples increased 40-50 times without any cracking of the protective film. On harvest it was found that only 1% of the treated apples had been attacked by insects whereas about 20% of the non-treated apples had been subjected to insect attacks. After washing the treated apples with water (38° C.) all the coating containing insecticide had been removed.

### Example 6

### Mulching Film

The solution from example 1 was mixed with 2% (w/v) carbon powder and was sprayed onto TAD (through-air-dried) tissue (SCA, Sweden) to 20.5 g/m². After drying, the black composite paper tissue was used as a mulch film. Some shrinking of the film was observed upon drying of the suspension. The mulching film was put onto a bed of soil in a greenhouse garden. No weeds could penetrate the film whereas plants put in openings of the film developed properly. Irrigating water passed easily through the film. If the film was buried into the ground it was broken down completely within one month.

### Example 7

### Enzymatic Removal at Room Temperature

A protective gelatin/gelatin hydrolysate film was prepared in accordance with Example 2.

The film along with pollutants such as bird droppings and graffiti (lacquer paints, felt pens etc.) could be removed from the concrete surface at room temperature by the following method. Bromelain enzyme (1% w/v) in water (pH 6-7) was sprayed onto the protected surface. The surface absorbed the solution and was then left over night. The enzyme degraded coating could then be removed together with contaminations using water at 15-30° C. and a low pressure 30-40 bars.

1. A protein/peptide composition for protection of surfaces comprising an aqueous solution of at least two components,
the first component (A) being a water-soluble protein or a mixture of water-soluble proteins having an average molecular weight Mw of at least 30000, and being capable of forming a gel, and
the second component (B) being a water-soluble peptide or a mixture of water-soluble peptides having an average molecular weight Mw of 200-10000, and being capable of inhibiting gel formation in said composition,
wherein the weight ratio between A and B is in the range of from 5:1 to 1:5 based on dry weight of A and B, and the total concentration of A and B in the composition is in the range of 0.1-30% (w/v) based on dry weight of A and B.

2. A protein/peptide composition according to claim 1, wherein A is selected from the group consisting of collagens, gelatins, caseins, keratins and soy bean proteins, and mixtures thereof.

3. A protein/peptide composition according to claim 1, wherein B is derived from the same protein as A.

4. A protein/peptide composition according to claim 1, wherein B comprises a hydrolysate of a protein.

5. A protein/peptide composition according to claim 1, further comprising at least one additive selected from the group consisting of an anti-foaming agent, a plasticizer, a surfactant, a primer, an antimicrobial agent, a preservative, an anti-moss agent, an insecticide, a fungicide, an herbicide, and a component for increasing the viscosity of the composition.

6. (canceled)

7. A process for the preparation of a protein/peptide composition suitable for application on surfaces comprising the steps:
a) mixing a first component (A) being a water-soluble protein or a mixture of water-soluble proteins having an average molecular weight Mw of at least 30 000, and being capable of forming a gel, and a second component (B) being a water-soluble peptide or a mixture of water-soluble peptides having an average molecular weight of about 200-10000, and being capable of inhibiting gel formation of A, water, and optionally other components, wherein the weight ratio between A and B is in the range of from 20:1 to 1:20 based on dry weight of A and B, and the total concentration of A and B in the composition is in the range of 0.1-30% (w/v) based on dry weight of A and B,
b) heating the mixture of a) to a temperature of at least 60° C. to dissolve the components A and B and optionally other components in the water, and
c) allowing the solution obtained in b) to cool down to room temperature.

8. A process for protecting a substrate from contamination and facilitating removal of contamination therefrom, comprising the following steps:
a) providing a protein/peptide composition as defined in claim 1,
b) applying the aqueous protein/peptide composition of a) to a substrate surface which is to be subjected to contamination, and
c) allowing the applied composition to dry to form a protective film on said substrate surface.

9. A process according to claim 8, further comprising the steps of:
d) treating the film formed in step c) with a liquid capable of redissolving and/or swelling the film, and
e) removing contamination deposited on the film by complete or partial removal of the film from the substrate surface.

10. A process according to claim 9, wherein said liquid capable of redissolving and/or swelling the film comprises an enzyme, or a functional portion of an enzyme, capable of degrading a protein or peptide present in the film.

11. A process according to claim 10, wherein said enzyme is selected from the group consisting of bromelain, papain, actinidin and ficin, or a mixture thereof.

12. A substrate having a surface coated with a protective film comprising a first component (A) being a water-soluble protein or a mixture of water soluble proteins having an average molecular weight Mw of at least 30000, and being capable of forming a gel, and a second component (B) being a water-soluble peptide or a mixture of water-soluble peptides having a molecular weight Mw of about 200-10000, and being capable of inhibiting gel formation of A, wherein the weight ratio between A and B is in the range of from 20:1 to 1:20 based on dry weight of A and B.

13. A process for protecting a plant or a plant part, comprising the following steps:
a) providing a protein/peptide composition as defined in claim 1 further comprising a plasticizer,
b) applying the aqueous protein/peptide composition of a to the surface of a plant or a plant part to be protected, and
c) allowing the applied composition to dry to form a protective film on said surface.
